(19) United States
(12) Patent Application Publication
(10) Pub. No.: US 2004/0191412 A1
(43) Pub. Date: Sep. 30, 2004

(54) Process for making ultra micro fiber artificial leather

(75) Inventors: Ching-Tang Wang, Taipei (TW); Mong-Ching Lin, Kaohsiung (TW); Chung-Chih Feng, Kaohsiung (TW); I-Peng Yao, Kaohsiung (TW); Chen-Hsiang Chao, Kaohsiung (TW); Ko-Feng Wang, Feng-Shan City (TW); Yung-Chang Hung, Kaohsiung (TW)

Correspondence Address: NIKOLAI & MERSEREAU, P.A., 900 SECOND AVENUE SOUTH, SUITE 820, MINNEAPOLIS, MN, 55402, US

(73) Assignee: San Fang Chemical Industry Co., LTD., Kaohsiung (TW)

(21) Appl. No.: 10/819,626

(22) Filed: Apr. 7, 2004

Related U.S. Application Data
(63) Continuation-in-part of application No. 10/386,290, filed on Mar. 11, 2003.

(30) Foreign Application Priority Data
Apr. 9, 2003 (TW) 92108313

(51) Int. Cl. B05D 5/00; D02G 3/00; B32B 27/34; B32B 27/36

(52) U.S. Cl. 427/245

(57) ABSTRACT

A process is disclosed for making ultra micro fiber artificial leather. Firstly, a substrate is made from ultra micro fibers of sea-island type and a reinforcement layer via needle punch or water jet. The ultra micro fibers all include a sea component and island components. Then, the sea component of each of the ultra micro fibers is dissolved. Finally, the substrate is submerged in elastomeric resin.

### CROSS REFERENCE TO RELATED APPLICATION

The present patent application is a continuation-in-part application of U.S. patent application Ser. No. 10/386,290 filed Mar. 16, 2003.

### FIELD OF INVENTION

The present invention relates to a process for making ultra micro fiber artificial leather.

### BACKGROUND OF INVENTION

To make artificial leather, a substrate is made from fibers spun of polymers. Then, the substrate undergoes several steps so as to become artificial leather. To make the artificial leather similar to real leather, the non-woven fabric substrate would better be made from sea-island type ultra micro fibers.

A typical process for making artificial leather with a substrate made from sea-island ultra micro fibers includes the following steps. At first, referring to FIG. 7, a substrate is made from sea-island type ultra micro fibers 100 each consisting of island components 102 and a sea component 104. Secondly, referring to FIG. 8, with a wet polymer-coating machine, the substrate is submerged in elastomeric resin 106. Finally, by means of solvent, the sea component 104 of each ultra micro fiber 100 of the substrate is dissolved, thus leaving the island components 102 as shown in FIG. 9. After the sea component 104 of each ultra micro fiber 100 of the substrate is dissolved, the fineness of the substrate is reduced. After being ground, the substrate exhibit a suede-like feel. Hence, the artificial leather with the substrate made from the sea-island ultra micro fibers provides a feel like that of real leather. However, the substrate is weak and inadequately solid so that the artificial made from it is low in density, weak in strength and vulnerable to deformation. Taiwanese Patent Publication No. 152961 discloses a process for making composite ultra micro fiber non-woven fabric similar to real leather. In this process, polymer or binder is provided on a substrate by means of a coating machine so as to set the substrate. For example, the substrate is coated with PVA. Then, the substrate is submerged in resin. Finally, the substrate undergoes reduction, i.e., removing of the sea component. In this process, binder is provided for some reasons. Firstly, the strength of the substrate is enhanced during the process. Secondly, the elasticity of resultant artificial leather is enhanced. Finally, the uniformity of the density of the resultant artificial leather is enhanced. However, before the reduction, the substrate is submerged in the resin and enclosed by means of the resin. Thus, solvent cannot penetrate the substrate easily. Hence, the reduction cannot be conducted effectively. In addition, the resin must be chosen so that it cannot be dissolved by means of the solvent used in the reduction. Therefore, the types of the resin are limited.

Referring to FIG. 10, a process for making artificial leather with a thermo-set surface generally includes an additional step of coating. With a wet polymer-coating machine, a substrate is coated with polymer resin after it is submerged in elastomeric resin. Then, the coating undergoes wet processing so as to form a foam layer 108 that exhibits elasticity like real leather. The foam layer 108 however interferes with the reduction. Hence, the step of coating must be taken after the reduction or saved.

If a process for making artificial leather does not include a step of coating, resultant artificial leather will lack elasticity, and the flatness of the surface of the artificial leather will be poor, and the texture of the surface of the artificial leather will be rough. The surface of the artificial leather cannot be subject to hot pressing effectively. Therefore, the usages of the artificial leather will be limited. If a step of coating is taken after the reduction, a substrate must be fed to a wet polymer-coating machine to undergo a step of submerging, then removed for the reduction and finally fed to the wet polymer-coating machine to undergo the step of coating. This process is complicated and inefficient.

In a process for making suede-like artificial leather disclosed in Taiwanese Patent Publication No. 257814, and in a process for making ultra micro fibers disclosed in Taiwanese Patent Publication No. 481687, the reduction is conducted after a substrate is submerged in resin.

### SUMMARY OF INVENTION

It is an objective of the present invention to provide a process for making artificial leather with adequate strength.

It is another objective of the present invention to provide a process for making artificial leather in which reduction is conducted before a step of submerging or a step of coating so that polymer formed because of the submerging or coating does not interfere with the reduction and that submerging or coating can be conducted separately or continuously so as to simplify the process and increase the efficiency.

According to the present invention, a process is provided for making artificial leather. Firstly, a substrate is made from ultra micro fibers of sea-island type and a reinforcement layer via needle punch or water jet. The ultra micro fibers all include a sea component and island components. The fineness of the ultra micro fibers is about 1 to 10 deniers. Then, the sea component of each of the ultra micro fibers is dissolved. With the sea component of each of the ultra micro fibers dissolved, the fineness of the ultra micro fibers is about 0.01 to 0.8 deniers. Finally, the substrate is submerged in a first type of elastomeric resin, or coated with a second type of elastomeric resin, or coated with a second type of elastomeric resin after it is submerged in the first type of elastomeric resin. The first type of elastomeric resin is selected from a group consisting of polyurethane resin, acrylic resin, polyamide resin and polyolefin resin. The second type of elastomeric resin is selected from a group consisting of polyurethane resin, acrylic resin, polyamide resin and polyolefin resin. It is preferred that the substrate is coated with a second type of elastomeric resin after it is submerged in the first type of elastomeric resin.

Preferably, after being submerged in the first type of elastomeric resin or coated with a second type of elastomeric resin, the substrate is subject to wet processing. The wet processing includes congealing, washing and drying. For including the reinforcement layer, the artificial leather made according to the present invention exhibits adequate strength. Thus, the substrate can undergo reduction, submerging and coating without the need for setting via providing binder. Thus, the first and second types of elastomeric resin will not be limited because of the reduction. The first type of elastomeric resin infiltrates all of the gaps in the substrate so that the artificial leather includes consistent density.

### BRIEF DESCRIPTION OF DRAWINGS

The present invention will be described via detailed illustration of embodiments referring to the drawings.

FIGS. 1-4 show four steps of a process for making artificial leather from ultra micro fibers of the sea-island type according to the present invention.

FIG. 5 is a cross-sectional view of the artificial leather made by the process shown in FIGS. 1-4.

FIG. 6 is a flowchart of a process for making artificial leather from ultra micro fibers of the sea-island type according to the present invention.

FIGS. 7-10 show four steps of a conventional process for making artificial leather from ultra micro fibers of the sea-island type.

### DETAILED DESCRIPTION OF EMBODIMENTS

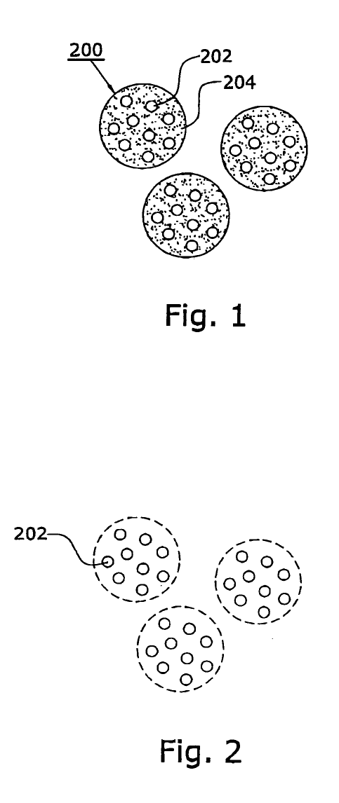

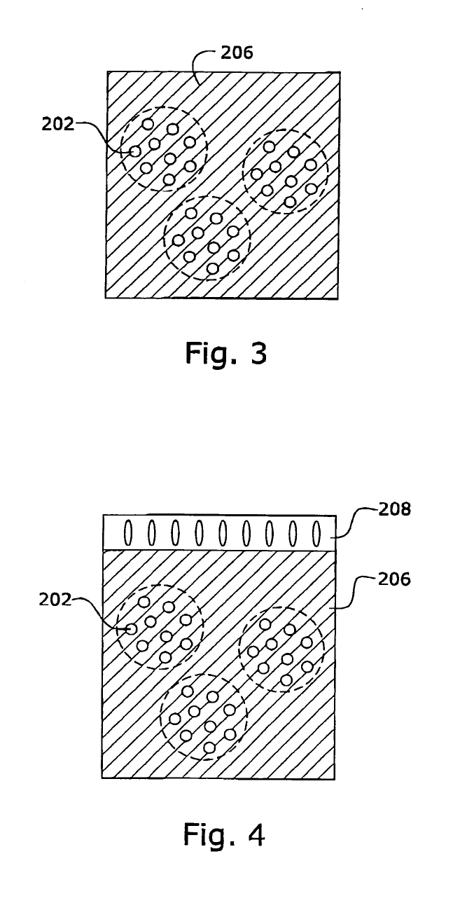

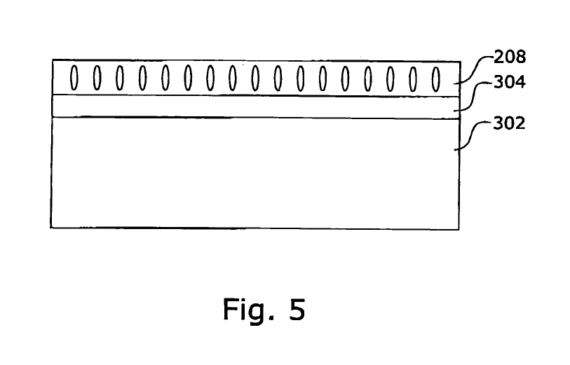

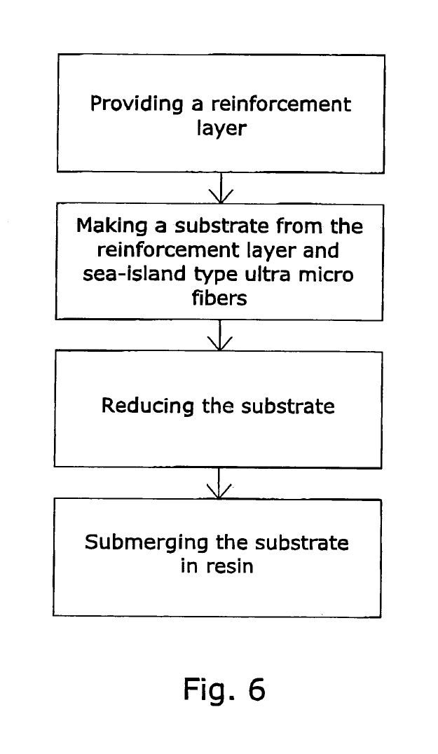

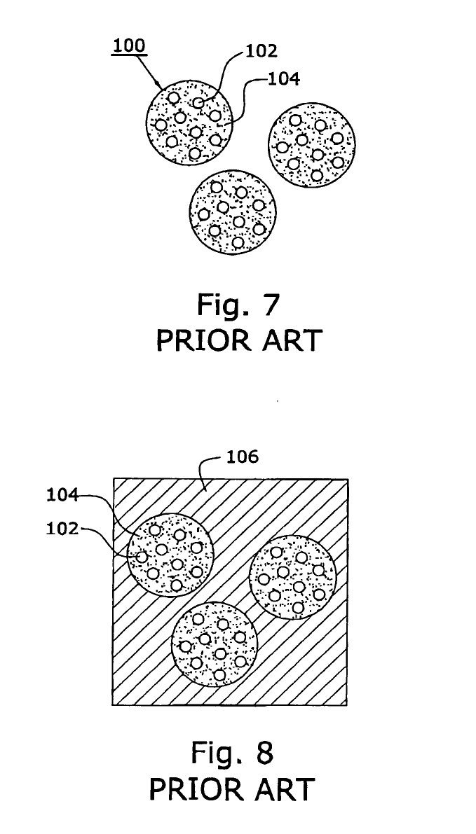

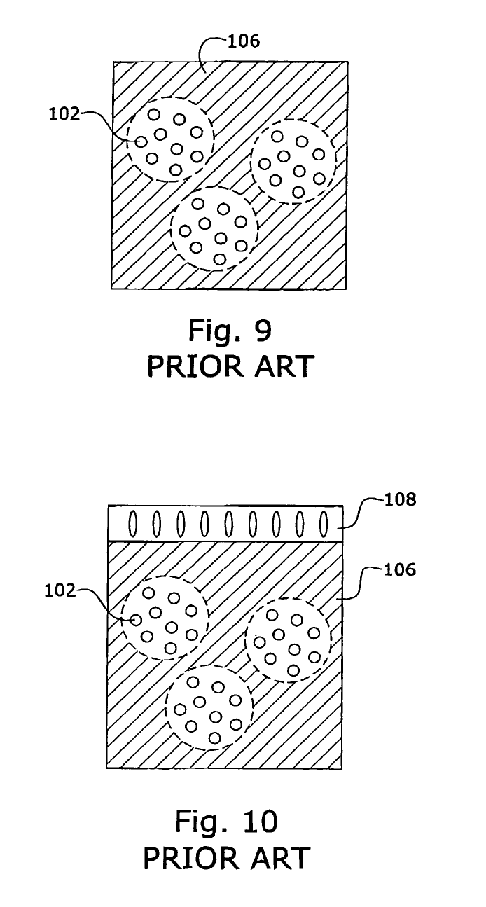

Referring to FIGS. 1 through 6, a process for making artificial leather from ultra micro fibers will be described. A substrate is made from ultra micro fibers 200 of the sea-island type and a reinforcement layer 304 by means of needle punch or water jet. Referring to FIG. 3, the substrate includes an ultra micro fiber layer 302 and the reinforcement layer 304. FIG. 1 shows several ultra micro fibers 200. Referring to FIG. 2, sea component 204 of each ultra micro fiber 200 is dissolved. Referring to FIG. 3, the substrate is submerged in a first type of elastomeric resin. Referring to FIG. 4, the substrate is coated with a second type of elastomeric resin so as to form a foam layer 208 (FIG. 5). The substrate is submerged in the first type of elastomeric resin (FIG. 3). Alternatively, the substrate is coated with the second type of elastomeric resin so as to form the foam layer 208 (FIG. 5).

Referring to FIG. 1, each ultra micro fiber 200 of the sea-island type is a fiber made via bi-component spinning or conjugate spinning. It includes two or more components with different dissolubility. In a cross-sectional view, the components look like a sea and some islands. Therefore, they are called the sea component 204 and the island components 202. According to the present invention, two of polyester (such as poly ethylene terephthalate (“PET”), poly trimethylene terephthalate (“PTT”), poly butylenes terephthalate (“PBT”) and any mixture thereof, nylon (such as nylon 6, nylon 66 and any mixture thereof and polyolefin (such as polyethylene, polyvinyl alcohol, high density polyethylene, low density polyethylene, polypropylene and polystyrene) can be used to make the sea component 204 and the island components 202. Preferably, the fineness of the ultra micro fibers 200 of the sea-island type is 1 to 10 deniers.

In the process for making artificial leather according to the present invention, the reinforcement layer 304 may be a reinforcement layer disclosed in U.S. patent application Ser. No. 10/386,290. According to U.S. patent application Ser. No. 10/386,290, polyester (such as poly ethylene terephthalate (“PET”), poly trimethylene terephthalate (“PTT”), poly butylenes terephthalate (“PBT”) and any mixture thereof), nylon (such as nylon 6, nylon 66 and any mixture thereof) or polyolefin (such as polyethylene, polyvinyl alcohol, high density polyethylene, low density polyethylene, polypropylene and polystyrene) can be used to make fibers via spun-bonding, melt-blowing or calendering. The fibers may be ordinary fibers with fineness of about 70 deniers or ultra micro fibers with fineness of about 0.05 to 10 deniers. A porous reinforcement layer can be made from these fibers via a spinning or knitting machine. Preferably, the reinforcement layer is a woven fabric, knit, spun-bond, spun-lace or any mixture thereof.

Referring to FIG. 2, solvent that can dissolve the sea component 204 but the island components is used to dissolve the sea component 204, and this step is called reduction. If the sea component is made from polyester, the solvent can be alkali. After the reduction, the substrate is dried so that the remaining island components are distributed so that the fineness of the fibers in the substrate is reduced to that of the island components (about 0.01 to 0.8 deniers) so that it feels like real leather. In addition, due to the substrate including a reinforcement layer, the substrate includes adequate strength against deformation after the reduction.

Referring to FIG. 3, after the reduction, the substrate is submerged in the first type of elastomeric resin. Five embodiments of the present invention will be described. In the first, second, third or fifth embodiment, a wet polymer-coating machine is used to conduct the step of submerging. Particularly, the wet polymer-coating machine includes a tank containing the first type of elastomeric resin in which the substrate can be submerged. After being fed to the wet polymer-coating machine, the substrate is submerged in the first type of elastomeric resin. Because the substrate has undergone the reduction, the first type of elastomeric resin can fully infiltrate the gaps between the island components. In the first, second, third or fifth embodiment, polyurethane resin, acrylic resin, polyamide resin, polyolefin resin or any mixture thereof can be used as the first type of elastomeric resin. In the first, second or fifth embodiment, after being submerged, the substrate is coated.

Referring to FIG. 4, in the first, second or fifth embodiment, after being submerged, the substrate is coated. The second type of elastomeric resin is provided on the substrate. Then, the substrate undergoes wet processing including congealing, washing and drying. Thus, the foam layer 208 is formed on the substrate. The foam layer 208 is elastic. Texture can be formed on the foam layer 208 via hot pressing so that the artificial leather feels much like real leather. In the first, second, fourth or fifth embodiment, polyurethane resin, acrylic resin, polyamide resin, polyolefin resin or any mixture thereof can be used as the second elastomeric resin.

Referring to FIG. 5, in the first, second, fourth or fifth embodiment, the second type of elastomeric resin is preferably provided on the reinforcement layer 304. Thus, the foam layer made of the second type of elastomeric resin can be firmly attached to the substrate. The step of submerging and the step of coating can be conducted in a same wet polymer-coating machine in order to simplify the process and save time. In another embodiment, after the reduction and before the step of submerging, if the substrate is processed with water borne polymer, i.e., submerged in water borne polymer such as polyvinyl alcohol, the artificial leather will be well set and includes consistent thickness.

In the first, second, third, fourth or fifth embodiment, as the substrate exhibits adequate strength for including a reinforcement layer, it can undergo the reduction before the step of submerging and the step of coating. Thus, the first and second types of elastomeric resin are not limited because of the solvent used in the reduction. Moreover, the first type of elastomeric resin infiltrates all of the gaps in the substrate so that the artificial leather includes high and consistent density.

First Embodiment

Reinforcement layers each including fineness of 3 deniers, weight of 40 g/m² and thickness of 0.1 mm are used to make a non-woven fabric including a weight of 400 g/m² and thickness of 1.0 mm by means of needle punch.

The substrate is fed to a reducing machine in which 10% wt alkali dissolves polyester molecules in ultra micro fibers of the sea-island type. After being washed and dried, nylon left in the substrate is reduced and spread out. Now, the fineness of nylon fibers in the substrate is 0.07 deniers. The thickness of the substrate is 1.0 mm.

A first mixture containing 6% wt of polyurethane, 1% wt of ink, 93% wt of DMF solvent is provided. A second mixture containing 28% wt of polyurethane, 2 % wt of additive, 7% wt of ink and 63% wt of DMF solvent is provided and de-aerated in a vacuum de-aerating machine. The substrate is fed to a wet polyurethane-coating machine in which it is submerged in the first mixture and coated with the second mixture.

Finally, the substrate is congealed, washed and dried so as to become artificial leather.

Second Embodiment

Reinforcement layers each including fineness of 3 deniers, weight of 40 g/m² and thickness of 0.1 mm are used to make a non-woven fabric including a weight of 400 g/m² and thickness of 1.0 mm by means of needle punch.

The substrate is fed to a reducing machine in which 10% wt alkali dissolves polyester molecules in ultra micro fibers of the sea-island type. After being washed and dried, nylon left in the substrate is reduced and spread out. Now, the fineness of nylon fibers in the substrate is 0.07 deniers. The thickness of the substrate is 1.0 mm.

A first mixture containing 6% wt of polyurethane, 1% wt of ink, 93% wt of DMF solvent is provided. A second mixture containing 28% wt of polyurethane, 2 % wt of additive, 7% wt of ink and 63% wt of DMF solvent as is provided and de-aerated in a vacuum de-aerating machine. The substrate is fed to a wet polyurethane-coating machine in which it is submerged in the first mixture, pre-congealed and coated with the second mixture.

Finally, the substrate is congealed, washed and dried so as to become artificial leather.

Third Embodiment

Reinforcement layers each including fineness of 3 deniers, weight of 40 g/m² and thickness of 0.1 mm are used to make a non-woven fabric including a weight of 400 g/m² and thickness of 1.0 mm by means of needle punch.

The substrate is fed to a reducing machine in which 10% wt alkali dissolves polyester molecules in ultra micro fibers of the sea-island type. After being washed and dried, nylon left in the substrate is reduced and spread out. The fineness of nylon fibers in the substrate is 0.07 deniers. The thickness of the substrate is 1.0 mm.

A mixture containing 6% wt of polyurethane, 1% wt of ink, 93% wt of DMF solvent is provided. The substrate is fed to a wet polymer-coating machine in which it is submerged in the mixture.

Finally, the substrate is congealed, washed and dried so as to become artificial leather.

Fourth Embodiment

Reinforcement layers each including fineness of 3 deniers, weight of 40 g/m² and thickness of 0.1 mm are used to make a non-woven fabric including a weight of 400 g/m² and thickness of 1.0 mm by means of needle punch.

The substrate is fed to a reducing machine in which 10% wt alkali dissolves polyester molecules in ultra micro fibers of the sea-island type. After being washed and dried, nylon left in the substrate is reduced and spread out. Now, the fineness of nylon fibers in the substrate is 0.07 deniers. The thickness of the substrate is 1.0 mm.

A mixture containing 28% wt of polyurethane, 2% wt of additive, 7% wt of ink and 63% wt of DMF solvent as is provided and de-aerated in a vacuum de-aerating machine. The substrate is fed to a wet polyurethane-coating machine in which it is coated with the mixture.

Finally, the substrate is congealed, washed and dried so as to become artificial leather.

Fifth Embodiment

Ultra micro fibers of the sea-island type are made from polystyrene. Each ultra micro fiber includes fineness of 2 deniers, weight of 40 g/m² and thickness of 0.1 mm. The ultra micro fibers are used to make a non-woven fabric including a weight of 450 g/m² and thickness of 1.5 mm by means of needle punch.

The substrate is fed to a reducing machine in which toluene dissolves the polystyrene in the ultra micro fibers of the sea-island type. After being washed and dried, nylon left in the substrate is reduced and spread out. Now, the fineness of nylon fibers in the substrate is 0.02 deniers. The thickness of the substrate is 1.1 mm.

A first mixture containing 9% wt of polyurethane, 1% wt of ink, 90% wt of DMF solvent is provided for submerging. A second mixture containing 28% wt of polyurethane, 2% wt of additive, 7% wt of ink and 63% wt of DMF solvent as is provided and de-aerated in a vacuum de-aerating machine for coating. The substrate is fed to a wet polyurethane-coating machine in which it is submerged in the first mixture and coated with the second mixture.

Finally, the substrate is congealed, washed and dried so as to become artificial leather.

A surfacing layer can be adhered to the artificial leather of the first, second, third, fourth or fifth embodiment can be or the artificial leather can be further furnished so that a texture can be provided on the artificial leather. Artificial leather made according to Taiwanese Patent Publication No. 152961 and five types of artificial leather made according to the embodiments of the present invention are compared and the comparison is outlined in the following table.

| | Thickness | Density | Strength (T) | Strength (Y) | Ductility (T) | Ductility (Y) |
|---|---|---|---|---|---|---|
| Taiwanese Patent | 1.0 mm | 0.3 g/cm³ | 5.8 kg | 5.8 kg | 72% | 112% |
| Publication No. | | | | | | |
| 152961 | | | | | | |
| First | 1.15 mm | 0.46 g/cm³ | 7.4 kg | 7.0 kg | 44% | 82% |
| Embodiment | | | | | | |
| Second | 1.2 mm | 0.45 g/cm³ | 7.2 kg | 6.9 kg | 46% | 88% |
| Embodiment | | | | | | |
| Third | 0.9 mm | 0.43 g/cm³ | 6.4 kg | 6.3 kg | 45% | 83% |
| Embodiment | | | | | | |
| Fourth | 1.1 mm | 0.37 g/cm³ | 5.8 kg | 5.5 kg | 63% | 91% |
| Embodiment | | | | | | |
| Fifth | 1.3 mm | 0.45 g/cm³ | 7.7 kg | 7.3 kg | 40% | 78% |
| Embodiment | | | | | | |
| Standard | CNS | | CNS 1279 | CNS 1279 | ASTM | ASTM |
| | 1274 | | | | D-1682 | D-1117 |

It is learned from the foregoing table that the strength of the artificial leather of the first, second, third, fourth or fifth embodiment is greater than that of the artificial leather of Taiwanese Patent Publication No. 152961. It is also learned from the foregoing table that the ductility of the artificial leather according to the first, second, third, fourth or fifth embodiment is smaller than that of the artificial leather of Taiwanese Patent Publication No. 152961. That is, the artificial leather according to the present invention is stronger and less vulnerable to deformation than the artificial leather of Taiwanese Patent Publication No. 152961.

The present invention has been described via detailed illustration of some embodiments. Those skilled in the art can derive variations from the embodiments without departing from the scope of the present invention. Therefore, the embodiments shall not limit the scope of the present invention defined in the claims.

1. A process for making ultra micro fiber artificial leather, comprising the steps of:
making a substrate from ultra micro fibers of sea-island type and a reinforcement layer via needle punch or water jet, wherein the ultra micro fibers all include a sea component and island components;
dissolving the sea component of each of the ultra micro fibers; and
submerging the substrate in a first type of elastomeric resin.

2. The process as set forth in claim 1 comprising a step of conducting wet processing on the substrate after it is submerged in the first type of elastomeric resin, wherein the wet processing comprises congealing, washing and drying.

3. The process as set forth in claim 1 comprising a step of coating the substrate with a second type of elastomeric resin after it is submerged in the first type of elastomeric resin.

4. The process as set forth in claim 3 comprising a step of conducting wet processing on the substrate after it is coated with the second type of elastomeric resin, wherein the wet processing comprises congealing, washing and drying.

5. The process as set forth in claim 4 comprising a step of pre-congealing the substrate after it is submerged in the first type of elastomeric resin and before it is coated with the second type of elastomeric resin.

6. The process as set forth in claim 1, wherein the ultra micro fibers are made from two selected from a group consisting of polyester, nylon and polyolefin that include different dissolubility.

7. The process as set forth in claim 1, wherein the reinforcement layer is made from at least one selected from a group consisting of polyester, nylon and polyolefin via spun-bonding, melt-blowing, calendaring, spinning or knitting so as to form a porous thin reinforcement layer with low fineness.

8. The process as set forth in claim 7, wherein the polyester is selected from a group consisting of poly ethylene terephthalate, poly trimethylene terephthalate and poly butylenes terephthalate.

9. The process as set forth in claim 1, wherein the reinforcement layer is made from at least one selected from a group consisting of fabric, knit, spun-bond and spun-lace.

10. The process as set forth in claim 1, wherein the first type of elastomeric resin is selected from a group consisting of polyurethane resin, acrylic resin, polyamide resin and polyolefin resin.

11. The process as set forth in claim 3, wherein the second type of elastomeric resin is selected from a group consisting of polyurethane resin, acrylic resin, polyamide resin and polyolefin resin.

12. The process as set forth in claim 3 comprising a step of setting the substrate via processing it with water-dissoluble elastomeric resin after the reduction and before the step of submerging.

13. A process for making ultra micro fiber artificial leather, comprising the steps of:
making a substrate from ultra micro fibers of the sea-island type and a reinforcement layer via needle punch or water jet, wherein the ultra micro fibers all include a sea component and island components;
dissolving the sea component of each of the ultra micro fibers; and
coating the substrate with elastomeric resin.

14. The process as set forth in claim 13 comprising a step of conducting wet processing on the substrate after it is coated with the elastomeric resin, wherein the wet processing comprises congealing, washing and drying.

15. The process as set forth in claim 13, wherein the ultra micro fibers are made from two selected from a group consisting of polyester, nylon and polyolefin that include different dissolubility.

16. The process as set forth in claim 13, wherein the reinforcement layer is made from at least one selected from a group consisting of polyester, nylon and polyolefin via spun-bonding, melt-blowing, calendaring, spinning or knitting so as to form a porous thin reinforcement layer with low fineness.

17. The process as set forth in claim 16, wherein the polyester is selected from a group consisting of poly ethylene terephthalate, poly trimethylene terephthalate and poly butylenes terephthalate.

18. The process as set forth in claim 13, wherein the reinforcement layer is made from at least one selected from a group consisting of fabric, knit, spun-bond and spun-lace.

19. The process as set forth in claim 13, wherein the elastomeric resin is selected from a group consisting of polyurethane resin, acrylic resin, polyamide resin and polyolefin resin.

20. The process as set forth in claim 13 comprising a step of setting the substrate via processing it with water-dissoluble elastomeric resin after the reduction and before the step of coating.
